(19) United States
(12) Patent Application Publication
(10) Pub. No.: US 2025/0024409 A1
(43) Pub. Date: Jan. 16, 2025

(54) SYSTEMS AND METHODS FOR INDICATING POSITIONING TIMING INFORMATION

(71) Applicant: ZTE Corporation, Shenzhen (CN)

(72) Inventors: Yu PAN, Shenzhen (CN); Guozeng ZHENG, Shenzhen (CN); Chuangxin JIANG, Shenzhen (CN); Zhaohua LU, Shenzhen (CN)

(73) Assignee: ZTE Corporation, Shenzhen (CN)

(21) Appl. No.: 18/606,711

(22) Filed: Mar. 15, 2024

Related U.S. Application Data
(63) Continuation of application No. PCT/CN2021/122030, filed on Sep. 30, 2021.

(51) Int. Cl. H04W 64/00; H04L 5/00; H04W 24/10

(52) U.S. Cl. CPC H04W 64/00; H04L 5/0051; H04W 24/10

(57) ABSTRACT

Presented are systems and methods for indicating positioning timing information. A wireless communication element can configure a first time period. The time stamps of reference signals for a positioning measurement may be restricted to be within the first time period. The wireless communication element can send a first message to activate the first time period.

### CROSS-REFERENCE TO RELATED APPLICATION

This application claims the benefit of priority under 35 U.S.C. § 120 as a continuation of International Patent Application No. PCT/CN2021/122030, filed on Sep. 30, 2021, the disclosure of which is incorporated herein by reference in its entirety.

### TECHNICAL FIELD

The disclosure relates generally to wireless communications, including but not limited to systems and methods for indicating positioning timing information.

### BACKGROUND

A location server is a physical or logical entity that can collect measurements and other location information from the device and base station, and can utilize the measurements and estimate characteristics such as its position. The location server can process a request from the device and can provide the device with the requested information.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A wireless communication element can configure a first time period. The time stamps of reference signals for a positioning measurement may be restricted to be within the first time period. The wireless communication element can send a first message to activate the first time period.

In some implementations, the wireless communication element can configure the first time period for a wireless communication device. The time stamps of Positioning Reference Signals(PRSs) for a RSTD measurement may be restricted to be within the first time period. In some implementations, the wireless communication element can configure the first time period for a wireless communication device, where the time stamps of Positioning Reference Signals(PRSs) and time stamps of Sounding Reference signals(SRSs) for a UE Rx-Tx time difference measurement may be restricted to be within the first time period.

In some implementations, a time when the wireless communication device receives the first message can correspond to a starting time of the first period. In some cases, a time when the wireless communication device receives the first message, together with a time offset value, collectively can correspond to a starting time of the first period. The first time period may be configured as a plurality of periodic time intervals. The first time period may be configured as a single time interval. In some implementations, the wireless communication element can configure the first time period for a wireless communication node, where time stamps of Sounding Reference Signals(SRSs) for a RTOA measurement may be restricted to be within the first time period.

In some implementations, the wireless communication element can configure the first time period for a wireless communication node, where time stamps of Positioning Reference Signals(PRSs) and time stamps of Sounding Reference signals(SRSs) for a gNB Rx-Tx time difference measurement may be restricted to be within the first time period. The wireless communication node may be a serving gNB or a neighboring gNB. In some cases, a time when the wireless communication node receives the first message can correspond to a starting time of the first period.

In some implementations, a time when the wireless communication node receives the first message, together with a time offset value, collectively can correspond to a starting time of the first period. The wireless communication element can receive a second message including a second time period from a wireless communication node or a wireless communication device. The second message can indicate a starting time stamp of the second time period.

The wireless communication element can send a third message requesting a wireless communication node or a wireless communication device to provide its corresponding third time period. The wireless communication element can receive a fourth message including the corresponding third time period from the wireless communication node or the wireless communication device. The fourth message can indicate a starting time stamp of the third time period. The first time period can correspond to an individual reference Transmission Reception Point (TRP).

In some implementations, the wireless communication element can receive, from a wireless communication device, a fifth message indicating an association relationship between an SRS resource or SRS resource set and a plurality of User Equipment Transmission Timing Error Groups (UE Tx TEGs) corresponding to the wireless communication device. The fifth message can indicate respective time stamps for the plurality of UE Tx TEGs. The wireless communication element can receive a sixth message from the wireless communication device, indicating a maximum number of the time stamps to which a single SRS resource or SRS resource set is allowed to correspond.

The wireless communication element can receive a seventh message from the wireless communication device, indicating a maximum number of the UE Tx TEGs to which a single SRS resource or SRS resource set is allowed to correspond. A wireless communication device can determine a starting time of a downlink reception from one TRP according to one or more PRS resources that are associated with a same User Equipment Reception Timing Error Group (UE Rx TEG) and are received within the first time period. A wireless communication node can determine a starting time of an uplink reception from one UE according to one or more SRS resources that are associated with a same TRP Rx TEG and are received within the first time period.

In some implementations, a wireless communication device can determine a starting time of a downlink reception from one TRP according to one or more PRS resources that are associated with a same UE Rx TEG. In some cases, a wireless communication node can determine a starting time of an uplink reception from one UE according to one or more SRS resources that are associated with a same TRP Rx TEG.

At least one aspect is directed to a system, method, apparatus, or a computer-readable medium. A wireless communication device or a wireless communication node can receive a first message to activate a first time period from a wireless communication element. The time stamps of reference signals for a positioning measurement may be restricted to be within the first time period.

The systems and methods presented herein include a novel approach for indicating positioning timing information. Specifically, the systems and methods presented herein discuss a novel solution for configuring and activating valid time periods and time stamps to minimize/mitigate/avoid/improve timing error shift over time in timing-based positioning operations. For instance, the location management function (LMF) can configure a time period to/for the user equipment (UE). The activation time of the time period can be the time that the UE receives the time period. In some cases, the activation time of the time period can be the time that the UE receives the time period plus/as well as/in addition to a configured time offset.

In some implementations, the LMF can configure a time period to serving gNB (e.g., location 5G radio node or base station) and neighboring gNBs. The activation time of the time period may be the time that the gNB receives the time period or the time that the gNB receives the time period in addition to a configured time offset. In some cases, the UE or gNB may report the time period to the LMF and/or the UE. In some cases, the UE and/or gNB may also report the start time stamp of the time period, such as to the LMF. The LMF can request the UE or gNB to provide its corresponding time period. In some implementations, each time period can be configured with a different reference TRP.

In some implementations, the UE may report the SRS time stamp together with SRS and UE Tx TEG association relationship. The UE may report its capability on the maximum number of time stamp associated with a single SRS resource. The UE can report its capability on the maximum number of Tx TEG ID associated with a single SRS resource. In some implementations, multiple PRS resources that determine the UE Rx timing should be/may be associated with a UE Rx TEG ID and within a time period. In some implementations, multiple SRS resources determining the gNB Rx timing should be associated with a gNB Rx TEG ID and within a time period.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a general procedures for the UE to measure a DL PRS and report a location measurement report in the certain NR positioning system, and procedures for configuring and activating valid time periods and time stamps, in accordance with some embodiments of the present disclosure; and

FIG. 4 illustrates a flow diagram of an example method for indicating positioning timing information, in accordance with an embodiment of the present disclosure.

### DETAILED DESCRIPTION

### 1. Mobile Communication Technology and Environment

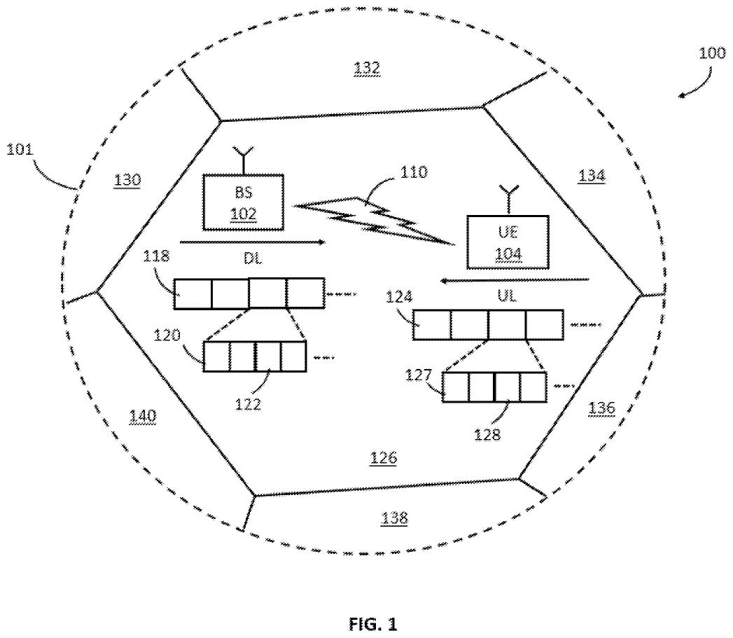

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

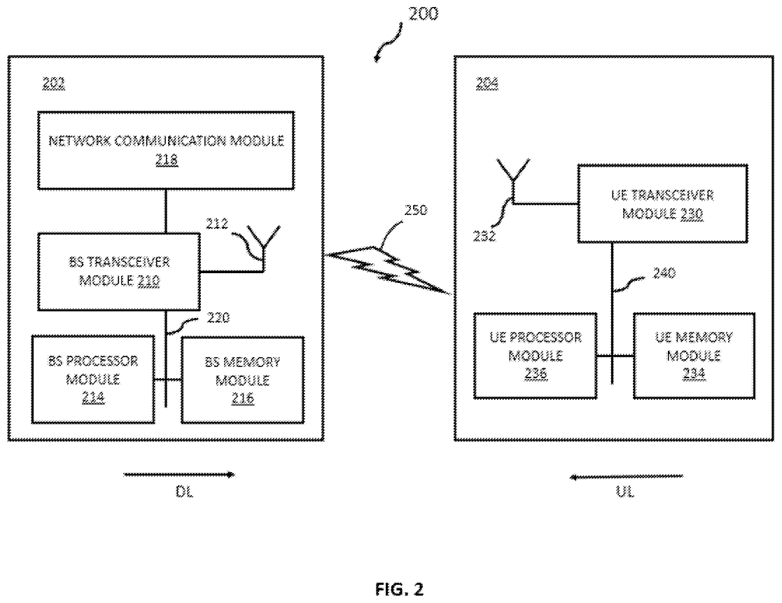

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Indicating Positioning Timing Information

In certain systems (e.g., 5G new radio (NR), Next Generation (NG) systems, 3GPP systems, and/or other systems), timing delays or timing errors may be introduced between the baseband and antenna both at TRP and UE side. For example, in certain systems, there may be timing error groups (TEG) in which the measurements or signals have/include/exhibit the same timing delays or timing errors. In this case, the timing errors may be shifted over time. Hence, when the different reference signals are associated with the same TEG and the timing gap of the reference signals is large, the timing error value may also be changed/modified/shifted. The systems and methods discussed herein can provide the configuration and activation of a valid time period and time stamp to address the timing error shift over time in timing-based positioning systems.

In new radio (NR), certain positioning methods are discussed to provide the UE with precise location information. In time-based positioning methods (e.g., DL/UL-TDOA or multi-RTT), there may be timing delays or timing errors between the baseband and antenna (e.g., at least at one of transmit/reception point (TRP) or UE side), which may perturb/derange/disrupt/interfere the measurement results. Due to the timing delay and the perturbed measurement results, certain systems may re-measure/re-evaluate or cancel the measurement results to acquire more accurate measurement (e.g., higher quality measurement or non-shifted results). In certain cases, there are timing error groups (TEG) (e.g., of the time-based positioning methods) in which the measurements or signals have the same timing delays or timing errors. For example, the timing errors may be shifted over time, such that when the different measurements or reference signals are associated with the same TEG, if the timing gap of the measurements or reference signals is large, the timing error value may change. In this case, the shifts in the timing errors can lead to/cause/introduce/result in the inaccuracy of the measurement. The systems and methods of this technical solution discussed herein can provide the configuration and activation of the valid time period and time stamp to mitigate timing error shift over time in timing-based positioning methods, among others.

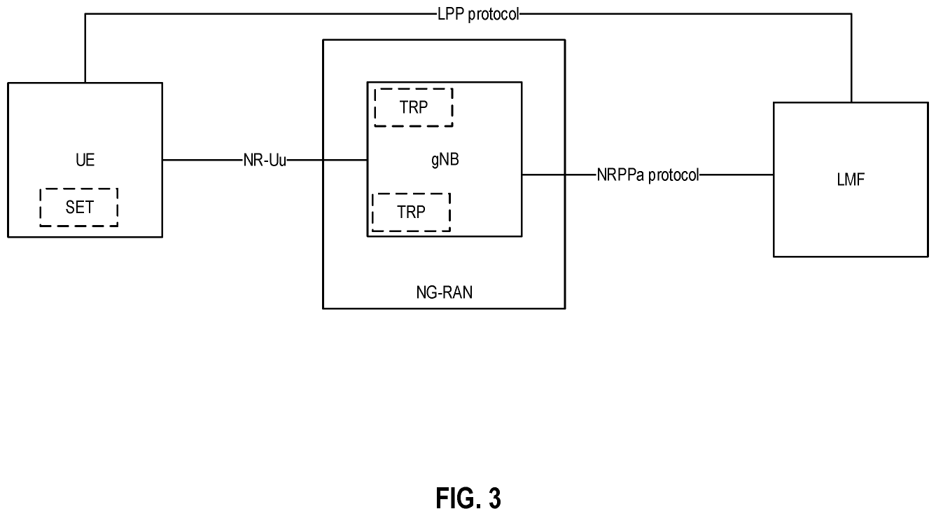

Referring to FIG. 3, depicted is an example illustration 300 of general procedures for the UE to measure a DL PRS and report a location measurement report in the certain NR positioning system, and procedures for configuring and activating valid time periods and time stamps. Multiple gNBs (e.g., a next generation NodeB (gNB), a base station (BS), the BS 102, the BS 202, a wireless communication node, a cell, a cell tower, a radio access device, a transmit receive point (TRP), etc.) such as a serving gNB and neighbor gNBs may provide a configured DL PRS to a location management function (LMF) via an NR positioning protocol A (NRPPa) protocol/interface in a transmit receive point (TRP) INFORMATION RESPONSE message. Before providing the configured DL PRS to the LMF, the TRP (or gNB-distributed unit (DU)) may provide configured DL PRS to a corresponding gNB (or gNB-centralized unit (CU)) via F1 application protocol (F1AP) protocol.

The LMF may provide the DL PRS configuration forwarded by gNBs to the UE via an LTE positioning protocol (LPP) protocol in a ProvideAssistanceData message. The LMF may configure some positioning frequency layer(s). In some embodiments, a positioning frequency layer is a collection of DL PRS resource sets across one or more TRPs which have a same sub-carrier spacing (SCS), cyclic prefix (CP) type, center frequency, reference frequency (e.g., point A), configured bandwidth (BW), and comb size.

One or multiple TRPs may be associated with each positioning frequency layer, which can be identified by a TRP identifier/identification (ID) information. One or multiple DL PRS resource sets can be associated with one TRP, which may be identified by a DL PRS resource set ID. One or multiple DL PRS resources may be configured within a DL PRS resource set, which can be identified by a DL PRS resource ID.

In some embodiments, the LMF requires the UE to provide location measurement report based on the DL PRS configuration in the ProvideAssistanceData message to derive requested contents. A request message may be via the LPP protocol in a RequestLocationInformation message. In some embodiments, the UE requires measurement gaps for performing the DL PRS measurements while measurement gaps are either not configured or not sufficient, where request signaling is transmitted from the UE to serving gNB via radio resource control (RRC) signaling.

The Serving gNB may provide a measurement configuration to the UE via RRC signaling. The measurement gap configuration may include the measurement gap length (MGL) of the measurement gap, measurement gap repetition period (MGRP) of the measurement gap, and the gap offset of the measurement gap pattern indicated by MGL and MGRP. The one or more components (e.g., BS 102, UE 104, BS 202, UE 204, or LMF) or operations of the components, such as in conjunction with FIGS. 1-3, can perform features or functionalities discussed herein for indicating positioning timing information (e.g., configuring or activating valid time periods and time stamps) to minimize/mitigate timing error shift over time in certain timing-based positioning systems.

In certain systems, the receive/transmit (Rx/Tx) timing delay between baseband and radio frequency (RF) chains may be embedded in the timing measurement due to/since the time point is recorded at baseband while the time duration to be measured for positioning (e.g., propagation time) is cut off at the antenna side both in TRP and UE. The timing delay can be called/referred to as/correspond to a timing error, transmission delay, transmission error, group delay, or group error. The TRP may include/correspond to a gNB or the base station (BS). The TEG can represent/correspond to/associated with or be a part of a group of uplink/downlink (UL/DL) positioning signals or DL/UL measurements. For instance, the UL/DL positioning signals and measurements may have similar/the same timing error or have the timing errors within a certain margin. The Tx TEG can indicate that the sending positioning signals in the group may have the same Tx timing error or have the timing errors within a certain margin. The Rx TEG can represent the UL or DL measurements in the group that has the same Rx timing error or has the timing errors within a certain margin. A TRP can include/contain multiple Tx TEGs and/or multiple Rx TEGs. A UE can contain multiple Tx TEGs and/or multiple Rx TEGs.

For example, the TEG may be divided according to/based on the dimension of the frequency layer, beam (e.g., spatial transmission filter), and/or panel (e.g., RF chain or antenna). In another example, the PRS resources or PRS resource sets in a frequency layer (e.g., with a sending beam) on one of the panels may be within one TRP Tx TEG. In further example, the PRS resources or PRS resource sets in another frequency layer (e.g., with the same sending beam) on the same panel may be within another TRP Tx TEG.

In some implementations, as an example, the gNB may assume/determine/identify that the PRS resources or PRS resource sets in a single TRP with the same configured/indicated coordinates are within one TRP Tx TEG. The gNB can assume that the UL measurements derived from SRS resources that are configured with the same coordinate PRS resources are within one TRP Rx TEG. In some cases, the gNB can assume that the UL measurements derived from SRS resources are configured with the PRS resources. In this case, the PRS resources may be within one TRP Tx TEG.

In some implementations, due to the environmental change (e.g., temperature, humidity, among other climate factors), the hardware (e.g., the antenna/panel) in a UE or a gNB may be affected, thereby affecting the timing error, which may change over time. The TEG identifier (ID) can be valid in a certain time period. For example, the TEG ID may be a local variable rather than a global variable, such that in each certain time period, the TEG may resort/recur and the TEG ID may be reordered. In such cases, the timing error shift over time may be periodic or aperiodic. In further example, for a UE, the DL measurements may contain or belong to one or more measurement types, such as received signal time difference (RSTD) measurements, received signal received power (RSRP) measurements, or Rx-Tx time difference measurements. For a TRP, the UL measurements may contain/include or belong to/be a part of one or more measurement types, such as relative time of arrival (RTOA) measurements, RSRP measurements, or Rx-Tx time difference measurements.

The sounding reference signal (SRS) resource discussed herein can refer to or represent an SRS for positioning, or regular configured SRS (e.g., SRS configured with usages). The SRS resource mentioned in this patent can be replaced by SRS resource set. The association relationship between SRS resources and UE Tx TEGs may be replaced by the association relationship between SRS resource sets and UE Tx TEGs. The gNB discussed herein can include/correspond to/be referred to as a serving gNB or the neighbor gNB. The term of base station can be interchangeable with other descriptive/related terms, such as gNB, TRP, NG-RAN node, ng-eNB, transmit point (TP), or receive point (RP). For instance, gNB Rx TEG ID may refer to TRP Rx TEG ID. In some implementations, the associated relationship between the SRS resources/SRS resource sets and the UE Tx TEGs can refer to/indicate that the SRS resource ID/SRS resource set ID includes an association relationship with UE Tx TEG ID. For instance, the SRS resource 1 and SRS resource 2 may be associated with UE Tx TEG 1 (e.g., first UE Tx TEG), or the SRS resource set 1 may be associated with UE Tx TEG 2 (e.g., second UE Tx TEG), among other combinations.

A. Implementation 1—Time Period Configuration/Activation from LMF to UE.

The LMF (e.g., wireless communication element) may configure a time period to UE (e.g., wireless communication device). Within the time period, the UE may assume/determine that the timing error value (e.g., actual timing error value) of at least one of the UE Rx TEG or the UE Tx TEG has not changed. In some cases, between two or more time periods, the UE may determine that the actual timing error value of UE Rx TEGs or UE Tx TEGs may be changed. For example, in a first time period (e.g., time period 1), the UE may include an Rx TEG 1 and Rx TEG 2. The two Rx TEGs (e.g., Rx TEG 1 and Rx TEG 2) may include different actual timing error values, but the actual timing error value of Rx TEG 1 and/or Rx TEG 2 may be stable during the first time period. In another example, in the first time period, the UE may include Rx TEG 1 and Rx TEG 2, and in time period 2, the UE may also include Rx TEG 1 and Rx TEG 2. In this example, the actual timing error value of Rx TEG 1 in time period 1 may not be the same as/equal to the actual timing error value of Rx TEG 1 in time period 2 (e.g., even when the actual timing error values are both ordered as/associated with Rx TEG 1). This may be due to timing error shifts over time. Hence, the time period may be used to restrict the behavior of the UE on receiving the positioning reference signals (PRSs), measuring PRSs, and/or transmitting SRSs.

In some implementations, in DL-time difference of arrival (TDOA), the UE can receive the PRS configuration from the LMF and the PRS signal from several TRPs. The UE may receive the time period from at least one of the LMF and/or the TRPs. The time period can be based on the current location or the current time of the UE. Within the activate time period, the UE can/should measure the PRSs from at least two TRPs, and the corresponding RSTD measurement may be (e.g., assumed to be) unaffected by timing error shift over time. For instance, both i) the time stamp associated with PRS resource from RSTD reference TRP, and ii) the time stamp associated with PRS resource from neighbor TRP for an RSTD measurement in a measurement report, may be within a single time period. The time stamp associated with PRS resource can represent/mean/indicate the reception time of the PRS resource. For example, the time interval or the time span between a time stamp associated with RSTD reference TRP and a time stamp associated with neighbor TRP for a single RSTD measurement in a measurement report may not be allowed to be larger/greater than the length of the time period. In some cases, the time interval or the time span of this example may not (e.g., not allowed to) cross different time periods. Otherwise, the RSTD may assume to be affected by timing error shift over time which may not be calibrated.

In some implementations, in DL-TDOA, the UE can receive the PRS configuration from the LMF and the PRS signal from several TRPs. The UE may receive the time period from at least one of the LMF or the TRPs. The time period can be based on the current location or the current time of the UE. Within the activate time period, the UE can measure different PRSs from a single TRP. The UE may measure different instances of a single PRS resource from a single TRP. The corresponding RSTD measurement may be assumed to be unaffected by timing error shift over time. For instance, the time stamp associated with different PRSs (or different instances of a PRS resource) for a RSTD measurement in a measurement report can be/should be within a single time period. The time stamp associated with PRS resource (or different instances of a PRS resource) can represent the reception time of PRS resource (or reception time of different instances of a PRS resource). For example, the time interval or time span between several time stamps of different PRSs (or different instances of a PRS resource) for a single RSTD measurement in a measurement report may not be allowed to be greater than the length of the time period. In some cases, the time interval or the time span may not be allowed to cross different time periods. Otherwise, the RSTD may assume to be affected by timing error shift over time which may not be calibrated.

In some cases, in multi-round trip time (RTT), the UE can receive the PRS configuration from the LMF and the SRS configuration from the serving gNB (e.g., serving BS or serving TRP). The UE may receive the time period from at least one of the LMF or the gNB. Within the time period, the UE can receive and/or measure the PRS signal. Further, the UE can transmit the SRS signal. The PRS and SRS may be used to determine a specific UE Rx-Tx time difference measurement. If the PRS and SRS are used to determine the specific UE Rx-Tx time difference measurement, the UE Rx-Tx time difference measurement may be (e.g., assumed to be) unaffected by the timing error shift over time. For instance, both the time stamp associated with DL PRS reception and the time stamp associated with SRS transmission (for a UE Rx-Tx time difference measurement in a measurement report) can be within a single time period. In another example, the time interval or the time span between a time stamp associated with DL PRS reception and the time stamp associated with SRS transmission (for a UE Rx-Tx time difference measurement in a measurement report) may not be allowed to be greater than the length of the time period. In some cases, the time interval or the time span may not be allowed to cross different time periods. Otherwise, the UE Rx-Tx time difference measurement can be assumed to be affected by timing error shift over time which may not be calibrated.

In some implementations, the time period can be a time value, such as 5 ms, 10 ms, 15 ms, etc. For example, in the LPP protocol, the time period can be configured in at least one of ProvideAssistanceData, NR-Multi-RTT-ProvideAssistanceData-r16, NR-DL-AoD-ProvideAssistanceData-r16, or NR-DL-TDOA-ProvideAssistanceData-r16. In further example, the activate request of the time period can be configured in the RequestLocationInformation, nr-Multi-RTT-RequestLocationInformation-r16, nr-DL-AoD-RequestLocationInformation-r16, or nr-DL-TDOA-RequestLocationInformation-r16. The time of the start of the time period can correspond to/be represented by/be associated with the time at which the UE receives the activation request (e.g., sometimes generally referred to as an activate request) of the time period contained in the information elements (IEs) as discussed herein above.

In another example, in the LPP protocol, the time period can be configured in at least one of ProvideAssistanceData, NR-Multi-RTT-ProvideAssistanceData-r16, NR-DL-AoD-ProvideAssistanceData-r16, or NR-DL-TDOA-ProvideAssistanceData-r16. The activation request of the time period and/or a time offset can be configured in RequestLocationInformation, nr-Multi-RTT-RequestLocationInformation-r16, nr-DL-AoD-RequestLocationInformation-r16, or nr-DL-TDOA-RequestLocationInformation-r16. The start of the time period can be the time at which UE receives the activate request of the time period containing in the IEs plus/including/in addition to/accounting for the time offset value.

As a third example, in LPP protocol, the time period can be configured in RequestLocationInformation, nr-Multi-RTT-RequestLocationInformation-r16, nr-DL-AoD-RequestLocationlnformation-r16, or nr-DL-TDOA-RequestLocationInformation-r16. In some cases, the time at which the UE receives the time period containing in the Ies can represent the time of the start (e.g., the starting time) of the time period.

In a fourth example, in LPP protocol, the time period and the time offset can be configured in RequestLocationInformation, nr-Multi-RTT-RequestLocationInformation-r16, nr-DL-AoD-RequestLocationInformation-r16, or nr-DL-TDOA-RequestLocationInformation-r16. In this example, the start of the time period can be the time at which the UE receives the time period containing in the above IEs in addition to the time offset value.

In some implementations, the time period can be periodic. For instance, for a time period to be periodic, once the time period is activated, the time period can operate/initiate/work periodically, such as until another time period or a stop flag (e.g., a termination instruction or a stop command) is received by the UE. In some cases, the time period can be one-shot (e.g., single-start), such that once the time period is activated, the time period may only work once. In this case, each time period configuration can correspond to an active time period. The indication of whether the time period is periodic or one-shot can be indicated explicitly to UE. For example, to indicate the type of time period (e.g., periodic or one-shot), a 1-bit parameter and time period value may be used. Further, if the time period is periodic, a periodicity value may be indicated (e.g., as an addition) to the UE together with the time period value.

B. Implementation 2—Time Period Configuration/Activation From LMF to gNBs.

In some implementations, the LMF can configure the time period to the gNBs. The time period may be used to restrict the behavior of the gNB to send PRSs, receive SRSs, and/or measure SRSs. The LMF can configure the time period for each of the serving gNBs and/or neighboring gNBs. In some cases, the time period of the serving gNBs and the neighboring gNBs may be the same. In some other cases, the time period of the serving gNBs and the neighboring gNBs may be different.

In UL-TDOA, the UE can receive the SRS configuration from the serving gNB. The UE can transmit SRSs according to the SRS configuration. The serving gNB and/or several neighboring gNBs may receive (e.g., attempt/try to receive) the SRSs. In some cases, if a gNB (e.g., serving gNB) can measure and report RTOA measurements based on multiple SRS resources, the received time of the measured multiple SRS resources can be within the same time period. In some cases, if i) the SRS is periodic, and a gNB can measure and report RTOA measurements based on multiple instances of a single SRS resource, the received time of multiple instances of the SRS resources should be within the same time period. For instance, the time stamps of different SRS resources (or different instances of an SRS resource) for a single RTOA measurement in a measurement report can be within a single time period. In further example, the time stamps of different SRS resources (or different instances of a SRS resource) can represent/indicate/refer to the reception time of SRS resources (or reception time of different instances of a SRS resource). Further, as an example, the time interval or the time span between several time stamps of different SRS resources (or different instances of a SRS resource) (e.g., for a single RTOA measurement in a measurement report) may not be (e.g., may not allow to be) larger than the length of the time period. In some cases, the time interval or the time span may not be allowed to cross different time periods.

In multi-RTT, the gNBs can send PRSs to the UE. The gNBs can receive SRSs sent by the UE. Each gNB receives a time period from LMF. Within the time period, individual gNBs can transmit PRS signals, where the gNB should receive and measure the SRS from the UE. The PRS and SRS may be used to determine a specific gNB Rx-Tx time difference measurement for the corresponding gNB (e.g., between individual the gNBs and the respective UE(s)). Accordingly, the gNB Rx-Tx time difference measurement can be unaffected by the timing error shift over time. For example, both the time stamp associated with the UL SRS reception and the time stamp associated with PRS transmission for a gNB Rx-Tx time difference measurement in a measurement report can be within a single time period. In further example, the time interval or time span between a time stamp (e.g., a first time stamp) associated with UL SRS reception and the time stamp (e.g., a second time stamp) associated with PRS transmission for a gNB Rx-Tx time difference measurement in a measurement report may not be larger than the length of the time period. In some cases, the time interval or time span may not cross different time periods. Otherwise, if the time interval and/or the time span is larger than the length of the time period and/or the cross different time periods, the gNB Rx-Tx time difference measurement may assume to be affected by the timing error shift over time that may not be calibrated.

In some implementations, according to the capability of each gNB, the LMF can configure the time period in NRPPa MEASUREMENT REQUEST to each gNB that participates in the positioning process/operation/method/technique. The start time (e.g., activation time) of the time period can be the time point (e.g., instant in time) at which the gNB receives the time period configuration. In some other cases (e.g., alternatively), the LMF can configure the time period in NRPPa MEASUREMENT REQUEST to each gNB that participates in this positioning process. In some cases, the LMF can configure a time offset in NRPPa MEASUREMENT REQUEST, NRPPa POSITIONING INFORMATION REQUEST, and/or NRPPa POSITIONING ACTIVATION REQUEST. The start time (e.g., activation time) of the time period may be the time point that the gNB receives the time period configuration in addition to the time offset value.

In some implementations, the time period can be periodic. For instance, once the time period is activated, the time period can work/initiate/start periodically until another time period or a stop flag is received by one or more gNBs. In some cases, the time period can be one-shot, such that when the time period is activated, the time period may start only once (e.g., each time period configuration can correspond to an active time period). The type of time period (e.g., periodic or one-shot) can be indicated explicitly to various gNBs, such as using a 1-bit parameter together with at least one time period value. In some cases, if the time period is periodic, a periodicity value may be indicated to gNBs together with the time period value, e.g., as an addition.

### C. Implementation 3—UE/gNB Reports the Time Period to LMF.

Environmental changes can affect the hardware and/or software components (e.g., antenna/panel in a UE or a gNB), which can cause the timing error to change over time. If the UE and/or the gNB identify/know/determine/obtain/calculate the frequency of timing error change (e.g., at least an estimate or an approximation) and/or how long the timing error is/can be assumed stable, the UE or gNB can report the corresponding time period to the LMF. Further, the UE or gNB can provide the measurements inside a single time period (rather than cross time periods).

In some implementations, the UE and/or the gNB may report the start time stamp (e.g., activation time/initiation time) of the time period. For example, the LMF can get/obtain/take the start time stamp of the time period and the length/duration of the time period. The LMF can receive the measurement results with/including the time stamp. Based on at least the time stamp from the UE and/or the gNB, the length of the time period, and/or the measurement results including the time period, the LMF can determine whether the measurement results are within a single time period or cross time periods. In further example, the LMF can determine whether the measurement results can be used to calculate the position of the UE. In some cases, the LMF can determine that the measurement results can be used to calculate the position of the UE. In some other cases, the LMF can determine that the measurement results may not be used to calculate the position of the UE.

In some implementations, the reported time period may be seen as/represent/correspond to/associated with the capability of at least the UE and/or gNB. For example, in LPP protocol, the UE can report time period value in ProvideCapabilities, NR-Multi-RTT-ProvideCapabilities-r16, NR-DL-AoD-ProvideCapabilities-r16, NR-DL-TDOA-ProvideCapabilities-r16, NR-UL-ProvideCapabilities-r16, and/or NR-ECID-ProvideCapabilities-r16. In another example, in NRPPa protocol, the gNB can report time period value in POSITIONING INFORMATION RESPONSE, TRP INFORMATION RESPONSE, and/or MEASUREMENT RESPONSE.

In some cases, the start time stamp of the time period of UE can be reported in RequestAssistanceData, NR-Multi-RTT-RequestAssistanceData-r16, NR-DL-AoD-RequestAssistanceData-r16, and/or NR-DL-TDOA-RequestAssistanceData-r16. In NRPPa protocol, the start time stamp (e.g., activation time stamp) of the time period of a gNB can be reported in POSITIONING ACTIVATION RESPONSE, TRP INFORMATION RESPONSE, POSITIONING INFORMATION RESPONSE, and/or POSITIONING INFORMATION UPDATE.

### D. Implementation 4—LMF Requests/Receives Time Period Reported by the UE/gNB.

In some cases, the LMF may not include/store the condition of the UE and/or gNB, such as the frequency of the timing error shift of UE or gNB. Hence, the LMF can request the UE and/or gNB to provide the corresponding time period. In LPP protocol, the request indication can be embedded in RequestCapabilities, CommonIEsRequestCapabilities, NR-Multi-RTT-RequestCapabilities-r16, NR-DL-AoD-RequestCapabilities-r16, NR-DL-TDOA-RequestCapabilities-r16, and/or NR-UL-RequestCapabilities-r16. In NRPPa protocol, the request indication can be embedded in POSITIONING INFORMATION REQUEST, TRP INFORMATION REQUEST, and/or POSITIONING ACTIVATION REQUEST.

In some implementations, responsive to/towards/subsequent to the request to report time period, the UE and/or gNB can report the time period to the LMF. The UE and/or gNB can provide the measurements to the LMF inside a single time period rather than cross time periods (e.g., may not provide the measurements cross time periods).

In some cases, in response to the request to report time period, the UE or gNB may report the activation time (e.g., start time stamp) of the time period. The LMF may retrieve/get/obtain/receive the activation time of the time period and/or the length of the time period from the UE/gNB. In some cases, the LMF may receive the measurement results with time stamp from the UE/gNB. Subsequently/in response, the LMF can determine whether the measurement results are within a single time period or cross time periods. The LMF can determine whether the measurement results can be used to calculate the position of the UE. For instance, the LMF can determine to use the measurement results to calculate the position if the measurement results are within a single time period. Otherwise, if the measurement results cross time periods, the LMF may determine to not use the measurement results.

In another example, the reported time period can indicate the capability of the UE/gNB. In LPP protocol, the UE can report time period value in ProvideCapabilities, NR-Multi-RTT-ProvideCapabilities-r16, NR-DL-AoD-ProvideCapabilities-r16, NR-DL-TDOA-ProvideCapabilities-r16, NR-UL-ProvideCapabilities-r16, and/or NR-ECID-ProvideCapabilities-r16. In NRPPa protocol, the gNB can report time period value in POSITIONING INFORMATION RESPONSE, TRP INFORMATION RESPONSE, and/or MEASUREMENT RESPONSE. In some cases, the start time stamp of the time period of UE can be reported in RequestAssistanceData, NR-Multi-RTT-RequestAssistanceData-r16, NR-DL-AoD-RequestAssistanceData-r16, and/or NR-DL-TDOA-RequestAssistanceData-r16. In some cases, the start time stamp of the time period of a gNB can be reported in POSITIONING ACTIVATION RESPONSE, TRP INFORMATION RESPONSE, POSITIONING INFORMATION RESPONSE, and/or POSITIONING INFORMATION UPDATE.

### E. Implementation 5—Each Time Period can Include Different Reference TRP.

For DL-TDOA positioning techniques in certain systems, the reference TRP selection may be per measurement report level. For instance, in those certain systems, the UE may select only one reference TRP in each measurement report. In this example, there may be several time periods between two consecutive measurement reports. For example, if all the RSTD measurements among the several time periods use the same reference TRP, there may be a timing error shift over time which may not be calibrated/adjusted/corrected. Therefore, as an example, the technical solution discussed herein can perform TRP selection per time period level. For instance, the UE can select at least one reference TRP in individual time periods. The reference TRPs selected in different time period may be the same. In some cases, the reference TRPs selected in different time period may be different.

F. Implementation 6—Report SRS Time Stamp Together with SRS and Tx TEG Association Relationship.

Due to the shift in timing error over time in certain systems, the same TEG ID in different time periods may include/have different actual timing error values. For example, the TEG may only be valid in one time period. Therefore, different instances of a periodic SRS resource associating with the same UE Tx TEG may have different actual timing error values. In some implementations, when the UE reports SRS and UE Tx TEG association relationship, the UE can report (e.g., in addition to reporting the SRS and UE Tx TEG) the corresponding time stamp of the SRS. Each SRS resource can be associated with multiple/several time stamps and/or several UE Tx TEGs.

In further example, the UE can report its capability (e.g., the capability of the UE) on the maximum number of time stamps that a single SRS resource and/or SRS resource set can be associated with (e.g., represented as N in the Table 1). In some cases, the UE can report its capability on the maximum number of different UE Tx TEG IDs that a single SRS resource or SRS resource set can be associated with (e.g., can be represented as N). As reproduced below, table 1 can include/illustrate/depict the reporting of the configuration of the SRS, time stamp, and UE Tx TEG ID.

TABLE 1

| | Time stamp 1 | Time stamp 2 | . . . | Time stamp N |
|---|---|---|---|---|
| SRS resource | UE Tx TEG ID | UE Tx TEG ID | . . . | UE Tx TEG ID |
| ID or SRS | | | | |
| resource set ID | | | | |

In some implementations, the UE can report the associated/association relationship of SRS and UE Tx TEGs to the serving gNB. The serving gNB can receive and decode the association relationship. In response to decoding the association relationship, the serving gNB can send the information to the LMF. In some cases, the UE can send the information directly to the LMF via/through non-access stratum (NAS) signaling and/or LPP protocol. In this case, the serving gNB may not (e.g., may not be responsible or configured to) decode the information.

### G. Implementation 7 Multiple PRS Resources Determining the Rx Timing Associated With an Rx TEG ID and Within the Same Time Period.

In DL-TDOA and multi-RTT positioning technique/method, such as in the specification of certain systems, for DL RSTD measurement and UE Rx-Tx time difference determination, when there is no timing error, the UE may determine the start of one DL subframe from one TRP according to all the PRS resources. For example, the UE may determine the start of the one DL subframe from one TRP according to all the PRS resources, since all the PRSs from the same TRP derive the same start of one DL subframe and share the same UE Rx timing, in this case. However, with timing error in those certain systems, which varies over/with time, only the PRSs having the same UE Rx TEG ID (and received in the same time period) can determine the same DL subframe boundary (e.g., share the same UE Rx timing). Hence, with the existence of the timing error, for DL RSTD measurement and UE Rx-Tx time difference determination, the UE can determine the start of at least one DL subframe from at least one TRP according to/based on the PRS resources having the same UE Rx TEG ID and received in the same time period. In some cases, the UE may determine the start of at least one DL subframe from at least one TRP according to the PRS resources having the same UE Rx TEG ID (e.g., may not be PRS resources received in the same time period).

In some cases, in UL-TDOA and multi-RTT positioning method, in the specification of certain systems, for UL RTOA measurement and gNB Rx-Tx time difference determination, when there is no timing error, gNB can determine the start of at least one UL subframe from the target UE according to all the SRS resources. The determination of the start of the at least one UL subframe can be made, since all the SRSs from the same UE derive the same start of one UL subframe and share the same gNB Rx timing. However, with the existence of the timing error that varies over time, only SRSs having the same TRP Rx TEG ID and received in the same time period can determine the same UL subframe boundary (e.g., share the same gNB Rx timing). Hence, with timing error, for UL RTOA measurement and gNB Rx-Tx time difference determination, the gNB may determine the start of at least one UL subframe from the target UE according to the SRS resources, where the SRS resources have the same TRP Rx TEG ID and received in the same time period. In some cases, the gNB can determine the start of at least one UL subframe from the target UE according to the SRS resources which have the same TRP Rx TEG ID (e.g., may not be TRP Rx TEG ID received in the same time period).

### H. Implementation 8—LMF Configures Time Stamp With PRS to UE.

The LMF can configure a time stamp with PRS resource level in the assistance data. The LMF can transmit the assistance data to the UE. The time stamp may be configured in close proximity/not too far away in time domain. Individual PRS resources may be configured with a time stamp. The time stamp can represent/correspond to/indicate when the LMF requests/wants/indicates to the UE to perform the PRS measurement. The indicated time stamp can be used to guide the UE to measure the PRS instance at the indicated time stamp. For example, the UE can receive two PRSs from two TRPs at the indicated time stamp. In this example, the UE can use the two PRSs in the corresponding time stamp to determine a DL-RSTD measurement.

In some implementations, the LMF may configure a time stamp with PRS resource set level in the assistance data. In response to the configuration, the LMF can transmit the assistance data to the UE. Each PRS resource set can be configured with a time stamp. Some PRS resource sets may be associated with a close time stamp (e.g., within a predetermined range of time). In some cases, the UE can use any PRS resources in the PRS resource sets which can be indicated close/within a proximity of the time stamp to determine a DL-RSTD measurement.

In some implementations, the LMF may configure a time stamp with TRP level in the assistance data. The LMF can transmit assistance data to the UE. Each TRP can be configured with a time stamp. The UE can receive the time stamp with TRP ID from the LMF. The UE can receive PRSs of the TRPs in the time stamp from the LMF. The UE can use/apply/deploy the PRSs received in the indicated time stamp to generate RSTD measurement. In some cases, the LMF can send the time stamp to the gNB. The time stamp may indicate when the gNB can/should perform SRS measurement for UL-RTOA and gNB Rx-Tx time difference.

### I. Implementation 9—UE Obtain a Time Window for Latency Reduction in MO-LR Periodic Assistance Data May not be Needed to be Pre-Configured.

In MO-LR, the UE can initiate/start/launch/send a positioning request. In response to imitating the positioning request, the UE can obtain its location information (e.g., location information of the UE). If there is a latency reduction requirement at the current scenario, when sending the MO-LR request, the UE can require/request a validity condition for the pre-configured assistance data to the network. The request of validity condition can be configured in the MO-LR Request message, the RequestAssistanceData, CommonIEsRequestAssistanceData, A-GNSS-RequestAssistanceData, OTDOA-RequestAssistanceData, EPDU-Sequence, Sensor-RequestAssistanceData-r14, TBS-RequestAssistanceData-r14, WLAN-RequestAssistanceData-r14, NR-Multi-RTT-RequestAssistanceData-r16, NR-DL-AoD-RequestAssistanceData-r16, and/or NR-DL-TDOA-RequestAssistanceData-r16.

The LMF can provide a validity condition as a response to UE (e.g., in response to receiving the validity condition). The indicated validity condition can be embedded in ProvideAssistanceData, commonIEsProvideAssistanceData, A-GNSS-ProvideAssistanceData, OTDOA-ProvideAssistanceData, EPDU-Sequence, Sensor-ProvideAssistanceData-r14, TBS-ProvideAssistanceData-r14, WLAN-ProvideAssistanceData-r14, NR-Multi-RTT-ProvideAssistanceData-r16, NR-DL-AoD-ProvideAssistanceData-r16, NR-DL-TDOA-ProvideAssistanceData-r16, RequestLocationInformation, CommonIEsRequestLocationlnformation, A-GNSS-RequestLocationInformation, OTDOA-RequestLocationInformation, ECID-RequestLocationInformation, EPDU-Sequence, Sensor-RequestLocationlnformation-r13, TBS-RequestLocationInformation-r13, WLAN-RequestLocationlnformation-r13, BT-RequestLocationInformation-r13, NR-ECID-RequestLocationlnformation-r16, NR-Multi-RTT-RequestLocationInformation-r16, NR-DL-AoD-RequestLocationlnformation-r16, or NR-DL-TDOA-RequestLocationlnformation-r16. In some cases, the validity condition can be a time window. For instance, within the time window, the UE can use the pre-configured assistance data to perform the measurements. The validity condition can be a list of cells, where within the cells, the UE can use pre-configured assistance data to perform the measurements. Hence, the periodic assistance data may not need to be pre-configured.

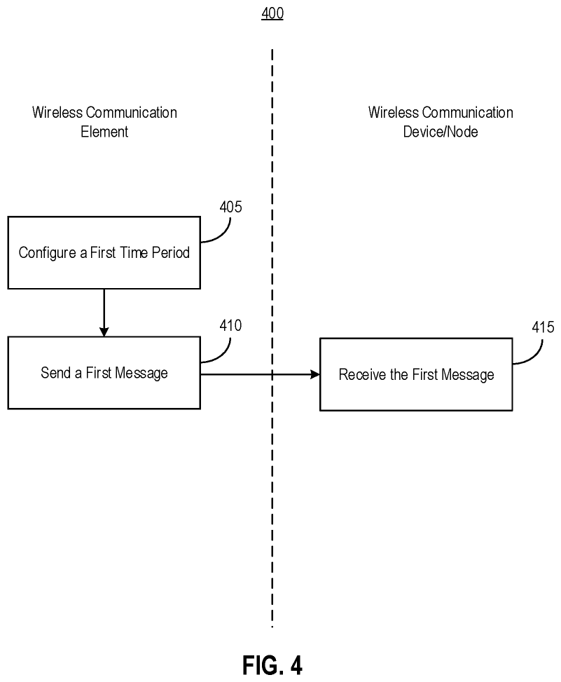

FIG. 4 illustrates a flow diagram of a method 400 for indicating positioning timing information. The method 400 may be implemented using any of the components and devices detailed herein in conjunction with FIGS. 1-3. For instance, the features/functionalities/operations/techniques discussed herein can be a part of/in addition to/correspond to one or more operations performed/executed by the one or more components in conjunction with FIGS. 1-3. In overview, the method 400 can include configuring a first time period (405). The method 400 can include sending a first message (410). The method 400 can include receiving the first message (415).

Referring now to operation (405), and in some implementations, a wireless communication element (e.g., LMF) can configure a first time period for at least a wireless communication device (e.g., UE) and/or a wireless communication node (e.g., gNB). The time stamps of reference signals for a positioning measurement may be restricted to be within the first time period. In some cases, the wireless communication element can configure the first time period for the wireless communication device, where the time stamps of Positioning Reference Signals (PRSs) for a RSTD measurement may be restricted to be within the first time period. In some cases, the wireless communication element can configure, for the wireless communication device, the first time period, where the time stamps of Positioning Reference Signals (PRSs) and/or time stamps of Sounding Reference signals (SRSs) for a UE Rx-Tx time difference measurement may be restricted to be within the first time period.

In some implementations, the first time period can be configured as multiple/various periodic time intervals. In some cases, the first time period is configured as a single time interval. In some cases, the wireless communication element can configure the first time period for the wireless communication node, where the time stamps of Sounding Reference Signals (SRSs) for a RTOA measurement may be restricted to be within the first time period. In some implementations, the wireless communication element can configure the first time period for a wireless communication node, where the time stamps of Positioning Reference Signals (PRSs) and time stamps of Sounding Reference signals (SRSs) for a gNB Rx-Tx time difference measurement may be restricted to be within the first time period. The wireless communication node can be at least one of a serving gNB or a neighboring gNB. In some cases, the first time period may correspond to an individual reference Transmission Reception Point (TRP).

Referring to operation (410), in response to configuring the first time period, the wireless communication element can send/transmit/forward a first message to the wireless communication node and/or the wireless communication device. The first message can activate the first time period. For instance, the wireless communication element can transmit the first message directly to the wireless communication device. In some cases, the wireless communication element can transmit the first message to the wireless communication node for forwarding to the wireless communication device to activate the first time period.

Referring to operation (415), in response to sending the first message, the wireless communication device or the wireless communication node can receive the first message from the wireless communication element. Upon receipt of the first message, the first time period can be activated, such as by the wireless communication device or the wireless communication node. The time stamps of reference signals for a positioning measurement may be restricted to be within the first time period.

In some cases, a time when the wireless communication device receives the first message corresponds to a starting time of the first period. In some cases, the time when the wireless communication device receives the first message, together with/as well as/plus/in addition to a time offset value, can collectively correspond to a starting time of the first period (e.g., the sum of the time offset value and the first message).

In some other cases, a time when the wireless communication node receives the first message can correspond to a starting time of the first period. In some implementations, the time when the wireless communication node receives the first message, together with a time offset value, can collectively correspond to a starting time of the first period. For instance, the starting time of the first period can be based on at least the first message and the time offset value. In some implementations, the wireless communication element can receive a second message from the wireless communication node or the wireless communication device. The second message can include a second time period. In some cases, the second message can indicate a starting time stamp (e.g., an activation time) of the second time period.

In some implementations, the wireless communication element may send a third message requesting that at least one of the wireless communication node and/or the wireless communication device provides its corresponding third time period (e.g., the time period of the wireless communication node and/or wireless communication device). In response to sending the third message, the wireless communication element can receive a fourth message from the wireless communication node or the wireless communication device. The fourth message can include the corresponding third time period from at least one of the wireless communication device or the wireless communication node. In some cases, the fourth message can indicate a starting time stamp of the third time period.

In some implementations, the wireless communication element can receive a fifth message from the wireless communication device. The fifth message can indicate an association relationship between an SRS resource or SRS resource set and multiple User Equipment Transmission Timing Error Groups (UE Tx TEGs) corresponding to the wireless communication device. In some cases, the fifth message may indicate respective time stamps for the plurality of UE Tx TEGs. In some implementations, the wireless communication element can receive a sixth message from the wireless communication device. The sixth message may indicate a maximum number of the time stamps to which a single SRS resource or SRS resource set is allowed to correspond. In some cases, the wireless communication element can receive a seventh message from the wireless communication device. The seventh message can indicate a maximum number of the UE Tx TEGs to which a single SRS resource or SRS resource set is allowed to correspond.

In some implementations, the wireless communication device can determine/identify/obtain a starting time of a downlink reception from at least one TRP according to/based on one or more PRS resources. The one or more PRS resources can be PRS resources that are associated with the same User Equipment Reception Timing Error Group (UE Rx TEG) and are received within the first time period. In some cases, the wireless communication node can determine the starting time of an uplink reception from at least one UE according to one or more SRS resources. In these cases, the one or more SRS resources can include/correspond to SRS resources that are associated with the same TRP Rx TEG and are received within the first time period.

In some implementations, the wireless communication device can determine a starting time of a downlink reception from at least one TRP according to one or more PRS resources. The one or more PRS resources can include PRS resources that are associated with the same UE Rx TEG. In some cases, the wireless communication node may determine a starting time of an uplink reception from at least one UE according to one or more SRS resources. In this case, the one or more SRS resources can include SRS resources that are associated with the same TRP Rx TEG.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A wireless communication method, comprising:
configuring, by a wireless communication element, a first time period, wherein time stamps of reference signals for a positioning measurement are restricted to be within the first time period; and
sending, by the wireless communication element, a first message to activate the first time period.

2. The wireless communication method of claim 1, further comprising:
configuring, by the wireless communication element for a wireless communication device, the first time period, wherein time stamps of Positioning Reference Signals (PRSs) for a reference signal timing difference (RSTD) measurement are restricted to be within the first time period.

3. The wireless communication method of claim 2, wherein the first time period is configured as a plurality of periodic time intervals.

4. The wireless communication method of claim 2, wherein the first time period is configured with a time offset value.

5. The wireless communication method of claim 1, further comprising:
configuring, by the wireless communication element for a wireless communication node, a second time period, wherein time stamps of Sounding Reference Signals (SRSs) for a relative time of arrival (RTOA) measurement are restricted to be within the second time period.

6. The wireless communication method of claim 5, wherein the wireless communication node is a serving gNB or a neighboring gNB.

7. The wireless communication method of claim 5, wherein the second time period is configured as a plurality of periodic time intervals.

8. The wireless communication method of claim 5, wherein the second time period is configured with a time offset value.

9. The wireless communication method of claim 5, wherein the second time period is configured without periodicity.

10. The wireless communication method of claim 1, further comprising:
sending, by the wireless communication element, a second message requesting a wireless communication node or a wireless communication device to provide its corresponding third time period; and
receiving, by the wireless communication element from the wireless communication node or the wireless communication device, a third message including the corresponding third time period.

11. The wireless communication method of claim 10, wherein the fourth message further indicates a starting time stamp of the third time period.

12. The wireless communication method of claim 1, wherein the first time period corresponds to an individual reference Transmission Reception Point (TRP).

13. The method of claim 1, further comprising:
receiving, by the wireless communication node from a wireless communication device, a fourth message indicating an association relationship between a Sounding Reference signal (SRS) resource or SRS resource set and a plurality of User Equipment Transmission Timing Error Groups (UE Tx TEGs) corresponding to the wireless communication device;
wherein the fourth message further indicates respective time stamps for the plurality of UE Tx TEGs.

14. The method of claim 13, further comprising:
receiving, by the wireless communication element from the wireless communication device, a fifth message indicating a maximum number of the time stamps to which a single SRS resource or SRS resource set is allowed to correspond.

15. The method of claim 13, further comprising:
receiving, by the wireless communication element from the wireless communication device, a sixth message indicating a maximum number of the UE Tx TEGs to which a single SRS resource or SRS resource set is allowed to correspond.

16. The method of claim 1, wherein a wireless communication device determines a starting time of a downlink reception from one Transmission Reception Point (TRP) according to one or more Positioning Reference Signal (PRS) resources that are associated with a same User Equipment Reception Timing Error Group (UE Rx TEG) and are received within the first time period.

17. The method of claim 1, wherein a wireless communication node determines a starting time of an uplink reception from one UE according to one or more Sounding Reference signal (SRS) resources that are associated with a same Transmission Reception Point Reception Timing Error Group (TRP Rx TEG) and are received within the first time period.

18. The method of claim 1, wherein a wireless communication device determines a starting time of a downlink reception from one Transmission Reception Point (TRP) according to one or more Positioning Reference Signal (PRS) resources that are associated with a same User Equipment Reception Timing Error Group (UE Rx TEG).

19. The method of claim 1, wherein a wireless communication node determines a starting time of an uplink reception from one UE according to one or more Sounding Reference signal (SRS) resources that are associated with a same Transmission Reception Point Reception Timing Error Group (TRP Rx TEG).

20. A wireless communication method, comprising:
receiving, by a wireless communication device or a wireless communication node from a wireless communication element, a first message to activate a first time period,
wherein time stamps of reference signals for a positioning measurement are restricted to be within the first time period.

21. A wireless communication element, comprising:
at least one processor configured to:
configure a first time period, wherein time stamps of reference signals for a positioning measurement are restricted to be within the first time period; and
send, via a transmitter, a first message to activate the first time period.

22. A wireless communication device or node, comprising:
at least one processor configured to:
receive, via a receiver from a wireless communication element, a first message to activate a first time period,
wherein time stamps of reference signals for a positioning measurement are restricted to be within the first time period.
